(19) United States
(12) Patent Application Publication
(10) Pub. No.: US 2009/0135683 A1
(43) Pub. Date: May 28, 2009

(54) DRIVE MECHANISM AND OPTICAL HEAD

(76) Inventors: Osamu Mizuno, Osaka (JP); Hiroshi Yamamoto, Kyoto (JP); Hideki Aikoh, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/066,282

(22) PCT Filed: Sep. 7, 2006
(86) PCT No.: PCT/JP2006/317770

§ 371 Date: Mar. 10, 2008

(30) Foreign Application Priority Data
Sep. 12, 2005 (JP) 2005-263383

(51) Int. Cl. G11B 7/00; H02N 2/04; B23Q 5/22

(52) U.S. Cl. 369/44.14; 74/99 R; 310/333; G9B/7

(57) ABSTRACT

A drive mechanism according to the present invention includes: a drive body that defines a longitudinal direction; a mover that makes a friction fit with the drive body so as to slide in the longitudinal direction; a base member that supports the drive body so as to allow the drive body to move in the longitudinal direction; a drive element, which is secured to one end of the drive body to vibrate the drive body in the longitudinal direction; and a viscoelastic body, which is arranged between the drive body and the base member in a direction perpendicular to the longitudinal direction.

### TECHNICAL FIELD

The present invention relates to a small drive mechanism and an optical head including such a mechanism.

### BACKGROUND ART

Recently, an increasing number of small image pickup devices such as cellphones with a shooting function and digital still cameras are equipped with an autofocusing function, a zooming function and an image stabilizer function. To realize these functions, a small drive mechanism for driving lenses and other members is built in those small image pickup devices more and more often.

Meanwhile, in optical disk drives (particularly in an optical head for an optical disk drive that is designed to perform high-density recording), a drive mechanism for driving lenses is included to correct the aberration of its optical system. As such an optical disk drive is frequently built in portable game consoles lately, the drive mechanism for driving lenses in such an optical head should also have its size reduced.

Likewise, even in the fields of micromanipulation, for example, there is a high demand for small drive mechanisms that realize fine movements.

As a small drive mechanism for use in those applications, a drive mechanism that utilizes vibrations and friction caused by a piezoelectric element has been proposed in order to replace conventional electromagnetic motors. For example, Patent Document No. 1 discloses a lens drive mechanism that uses a piezoelectric element. As shown in FIG. 17, the drive mechanism includes a drive element 12, in which a number of piezoelectric bodies have been stacked one upon the other, and a drive body 17. When a voltage is applied thereto, the piezoelectric bodies expand or shrink in the thickness direction, thereby vibrating the drive body 17 in its longitudinal direction (or axial direction) A. In this manner, by utilizing the vibrations of the drive body 17, a lens or any other member is driven. This piezoelectric element has such a simple structure as to have its size reduced easily, thus contributing to downsizing the overall drive mechanism greatly.

Patent Document No. 1: Japanese Patent No. 2633066

### DISCLOSURE OF INVENTION

### Problems to be Solved by the Invention

However, unless the center of mass of the member to be moved such as a lens is located on the drive body 17 when the displacement of the drive body 17 caused by the vibrations is transformed into the movement of that member, the displacement of the drive body 17 in the longitudinal direction A produces a moment on that member around its center of mass. If the member and the drive body 17 are constrained so as not to move freely, that moment also acts on the drive body 17. As a result, the drive body 17 vibrates in the directions indicated by the arrows B.

Such vibrations have few attenuation components that would dissipate the energy, and therefore, will last long. As a result, the lens or any other member will also vibrate continuously. And depending on the application, such vibrations could have serious consequence. For example, the vibrations of a mirror cylinder built in an optical head will cause disturbance in the servo system. And if the vibrations cause instability, the servo system should wait until the vibrations settle. As a result, the processing time of the servo system will increase to cause a decrease in efficiency.

In order to overcome the problems described above, the present invention has an object of providing a drive mechanism with reduced unnecessary vibrations.

### Means for Solving the Problems

A drive mechanism according to the present invention includes: a drive body that defines a longitudinal direction; a mover that makes a friction fit with the drive body so as to slide in the longitudinal direction; a base member that supports the drive body so as to allow the drive body to move in the longitudinal direction; a drive element, which is secured to one end of the drive body to vibrate the drive body in the longitudinal direction; and a viscoelastic body, which is arranged between the drive body and the base member in a direction perpendicular to the longitudinal direction.

In one preferred embodiment, the viscoelastic body is arranged at least in the vicinity of the other end of the drive body that is opposite to the end to which the drive element is secured.

In this particular preferred embodiment, the base member includes a bearing portion that has a first surface, which is arranged with a predetermined gap left in the perpendicular direction with respect to the drive body and which limits the movable range of the drive body in the perpendicular direction.

In an alternative preferred embodiment, the base member includes at least two bearing portions, each of which has a first surface that is arranged with a predetermined gap left in the perpendicular direction with respect to the drive body. And the viscoelastic body is arranged in one of the bearing portions that is most distant from the drive element.

In another preferred embodiment, the viscoelastic body is arranged between the first surface and the drive body.

In still another preferred embodiment, the bearing portion has a second surface that is arranged with another predetermined gap left in the perpendicular direction with respect to the drive body. The gap between the second surface and the drive body is greater than the gap between the first surface and the drive body.

In this particular preferred embodiment, the gap to the second surface changes in the longitudinal direction.

In yet another preferred embodiment, the bearing portion has two surfaces as the second surface, and those two surfaces are arranged so as to interpose the first surface in the longitudinal direction.

In yet another preferred embodiment, the first and second surfaces of the bearing portion are adjacent to each other as viewed on a plane that is parallel to the perpendicular direction.

In yet another preferred embodiment, the viscoelastic body is arranged so as to connect the other end of the drive body that is opposite to the end to which the drive element is secured and the base member together.

In this particular preferred embodiment, the viscoelastic body is sheet.

In a specific preferred embodiment, the sheet viscoelastic body has first and second principal surfaces. The first principal surface is in close contact with the end face of the drive body and with the base member, while the second principal surface is provided with a substance that has a greater modulus of shear elasticity than the viscoelastic body.

In one preferred embodiment, the viscoelastic body is made of a gel substance.

In another preferred embodiment, the viscoelastic body is made of a silicone substance.

In still another preferred embodiment, the viscoelastic body is made of a UV curable resin.

In yet another preferred embodiment, the viscoelastic body has a vibration loss factor of 1.4 to 1.7.

In yet another preferred embodiment, the drive element is a piezoelectric element.

In yet another preferred embodiment, the drive element is secured to one end of the drive body and vibrates the drive body in the longitudinal direction at varying velocities or accelerations that change according to the direction of movement, thereby shifting the mover.

An optical head according to the present invention includes: a light source; an optical element, which is arranged on the optical path of light emitted from the light source; and a drive mechanism for moving the optical element according to any of the preferred embodiments of the present invention described above. The optical head performs read and/or write operation(s) on a storage medium by converging the light emitted from the light source on the storage medium.

In one preferred embodiment, as viewed on a plane that passes the center of mass of the mover and that intersects with a drive shaft at right angles, a line segment that connects the center axis of the drive shaft and the center of mass of the mover together is parallel to a recording track in the vicinity of a light beam spot on the storage medium.

### EFFECTS OF THE INVENTION

According to the present invention, in the direction perpendicular to the longitudinal direction of a drive body, a viscoelastic body is arranged between the drive body and a base member that limits the vibration direction of the drive body. Thus, the vibrations of the drive body perpendicular to the longitudinal direction are damped by the shearing deformation of the viscoelastic body. As a result, this drive mechanism can drive a mover with good stability with unnecessary vibrations damped. Also, an optical head including the drive mechanism of the present invention realizes stabilized servo control.

### BRIEF DESCRIPTION OF DRAWINGS

FIG. 1 is a perspective view illustrating a first preferred embodiment of a drive mechanism according to the present invention.

FIG. 2 illustrates the principal part of the drive mechanism shown in FIG. 1.

FIG. 3A illustrates how the viscoelastic body deforms as the drive body is displaced in the drive mechanism shown in FIG. 1.

FIG. 3B illustrates how the viscoelastic body deforms as the drive body is displaced in the drive mechanism shown in FIG. 1.

FIG. 4A illustrates how the viscoelastic body deforms as the drive body is displaced in the drive mechanism shown in FIG. 1.

FIG. 4B illustrates how the viscoelastic body deforms as the drive body is displaced in the drive mechanism shown in FIG. 1.

FIG. 5A shows how the drive body vibrates in a situation where the drive mechanism shown in FIG. 1 has no viscoelastic body.

FIG. 5B shows how the drive body vibrates in the drive mechanism shown in FIG. 1.

FIG. 6 illustrates the principal part of a drive mechanism as a second preferred embodiment of the present invention.

FIG. 7A illustrates the principal part of a drive mechanism as a third preferred embodiment of the present invention.

FIG. 7B illustrates the principal part of the drive mechanism as the third preferred embodiment of the present invention.

FIG. 7C illustrates the principal part of the drive mechanism as the third preferred embodiment of the present invention.

FIG. 8 illustrates the principal part of a drive mechanism as a fourth preferred embodiment of the present invention.

FIG. 9 illustrates the principal part of a drive mechanism as a fifth preferred embodiment of the present invention.

FIG. 10A illustrates the principal part of a drive mechanism as a sixth preferred embodiment of the present invention.

FIG. 10B illustrates the principal part of the drive mechanism as the sixth preferred embodiment of the present invention.

FIG. 10C illustrates the principal part of the drive mechanism as the sixth preferred embodiment of the present invention.

FIG. 11A illustrates the principal part of a drive mechanism as a seventh preferred embodiment of the present invention.

FIG. 11B illustrates how the viscoelastic body deforms as the drive body is displaced in the drive mechanism shown in FIG. 11A.

FIG. 12A illustrates the principal part of a drive mechanism as an eighth preferred embodiment of the present invention.

FIG. 12B illustrates how the viscoelastic body deforms as the drive body is displaced in the drive mechanism shown in FIG. 12A.

FIG. 13A illustrates, as a mesh model, how the viscoelastic body deforms as the drive body is displaced in the drive mechanism shown in FIG. 12A.

FIG. 13B illustrates, as a mesh model, how the viscoelastic body deforms as the drive body is displaced in the drive mechanism shown in FIG. 12A.

FIG. 14 illustrates an optical head as a ninth preferred embodiment of the present invention.

FIG. 15 illustrates the optical head as the ninth preferred embodiment of the present invention.

FIG. 16 illustrates an optical head as a tenth preferred embodiment of the present invention.

FIG. 17 illustrates how a drive body vibrates in a drive mechanism.

### DESCRIPTION OF REFERENCE NUMERALS

5, 8 viscoelastic body
12 piezoelectric element
13a, 13b bearing portion
13b, 13d hole
17 drive shaft
24 semiconductor laser
25 aberration correction lens
26 objective lens
27 storage medium
100 drive mechanism

### BEST MODE FOR CARRYING OUT THE INVENTION

### Embodiment 1

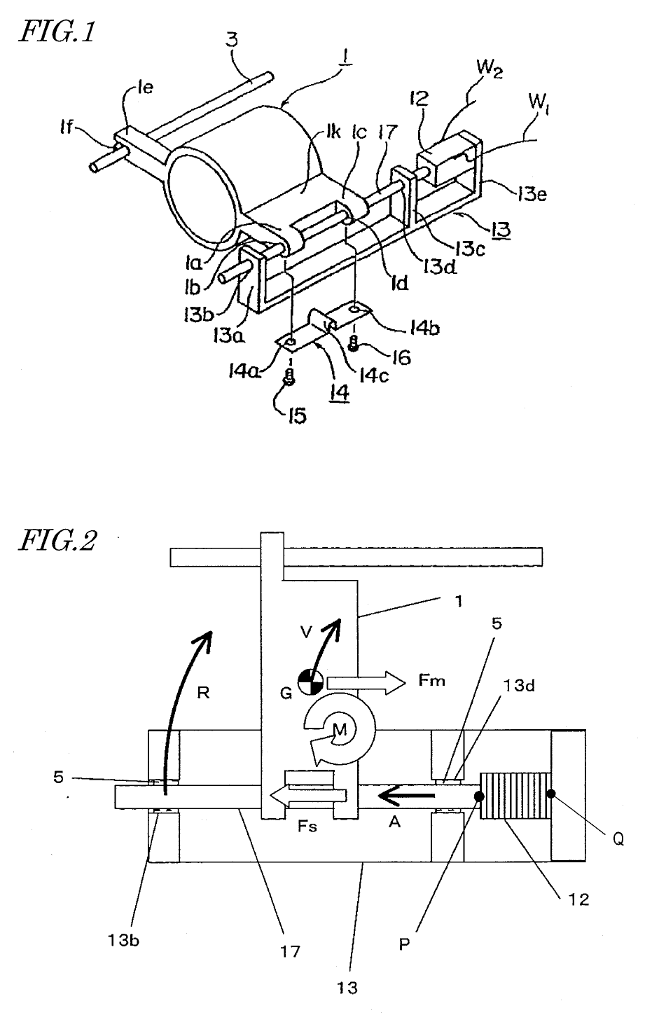

FIG. 1 is a perspective view illustrating a first preferred embodiment of a drive mechanism according to the present invention. The Drive Mechanism of this Preferred embodiment includes a mover 1, a drive body 17, a drive element 12, and a base member 13.

The drive mechanism of this preferred embodiment is provided for an optical head in order to drive an optical element such as a lens, which is arranged along an optical path in an optical system, and to adjust its position. For that purpose, the mover 1 has a built-in optical element (not shown).

The drive body 17 defines a longitudinal direction and preferably has a shaft shape. As viewed on a plane that is perpendicular to the longitudinal direction, the drive body 17 may have a circular or polygonal cross section. In this preferred embodiment, the drive body 17 has a circular cross section.

The mover 1 includes a supporting plate portion 1k and an arm 1e, which both protrude horizontally and extend in mutually opposite directions. The supporting plate portion 1k includes protruding portions 1a and 1c that have holes 1b and 1d, respectively. The drive body 17 is inserted into the holes 1b and 1d, thereby supporting the mover 1 thereon. Also, as will be described later, the mover 1 makes a friction fit with the drive body 17 so as to slide in the longitudinal direction of the drive body 17.

A U-groove if has been cut horizontally at the end of the arm 1e of the mover 1. An auxiliary guide 3 has been inserted into the groove if so as to slide thereon. In this manner, the mover 1 is supported on the auxiliary guide 3 and has its rotation around the drive body 17 constrained.

The base member 13 has a pair of bearing portions 13a and 13c, which have holes 13b and 13d, respectively. The drive body 17 is inserted into these holes 13b and 13d.

These holes 13b and 13d are defined by cylindrical inner faces (corresponding to the first surface). Each of these inner faces defines a circle, of which the diameter is slightly greater than that of the circular cross section of the drive body 17. The inner face is located with a predetermined very small gap left with respect to the side surface of the drive body 17. That is why the drive body 17 is freely movable in the longitudinal direction but is movable only within the predetermined gap in the direction perpendicular to the longitudinal direction.

Both ends of the drive body 17 stick out of the bearing portions 13a and 13c. The rear end of the bearing portion 13c of the drive body 17 is secured to the drive element 12 with an adhesive, for example.

A screw hole has been bored through the lower surface of the protruding portions 1a and 1c of the mover 1. A rectangular leaf spring 14, which has holes 14a and 14b at both ends so as to face those screw holes, is attached parallel to the lower surface of the protruding portions 1a and 1c with screws 15 and 16. A folded portion 14c protruding toward the drive body 17 is provided at the middle of the leaf spring 14. The folded portion 14c presses the lower side of the drive body 17 at an intermediate position between the protruding portions 1a and 1c. As a result, the drive body 17 is shifted upward in the respective holes 1b and 1d of the protruding portions 1a and 1c and the upper peripheral side of the drive body 17 is pressed against the upper part of the inner face of the holes 1b and 1d due to the elastic restitution force of the leaf spring 14. That is why if force smaller than the sum of the frictional force between the holes 1b, 1d and the drive body 17 and the frictional force between the folded portion 14c and the drive body 17 is applied to the drive body 17 in the longitudinal direction, the mover 1 and the drive body 17 move together. On the other hand, if force greater than the sum of these frictional forces is applied to the drive body 17, then only the drive body 17 moves in the axial direction.

The drive element 12 is secured to one end of the drive body 17 and vibrates the drive body 17 in the longitudinal direction. The drive element 12 is preferably a piezoelectric element. When a potential difference is produced between lead wires W1 and W2, the drive element 12 either expands or shrinks in the longitudinal direction of the drive body 17 according to the polarity of the potential difference. For example, if a higher voltage is applied to the lead wire W1 than to the other lead wire W2, the drive element 12 will expand. The drive element 12 is secured to the base member 13.

If a voltage is applied to the lead wires W1 and W2 of the drive element 12 such that the potential at the lead wire W1 is positive and that the potential difference between the lead wires W1 and W2 gradually increases, then the drive element 12 expands and the drive body 17 gradually moves toward its free end (to which the drive element 12 is not connected). In this case, since the expansion force of the drive element 12 that causes the drive body 17 to move in the longitudinal direction is smaller than the sum of the frictional force between the holes 1b, 1d and the drive body 17 and the frictional force between the folded portion 14c and the drive body 17, the mover 1 moves along with the drive body 17.

If the voltage between the lead wires W1 and W2 of the drive element 12 is suddenly removed in such a state, then the drive element 12 will shrink rapidly and the drive body 17 will move toward the drive element 12 just as rapidly. However, even if the mover 1 is accelerated toward the drive element 12, inertial force will be produced according to the mass of the mover 1. The mover 1 is making a frictional fit with the drive body 17 with the restitution force of the leaf spring 14. That is why if the static frictional force of the friction fit exceeds the inertial force, then the mover 1 will slide on the drive body 17 while being subjected to kinetic frictional force. As a result, the mover 1 will substantially stay put irrespective of the displacement of the drive body 17 toward the drive element 12 (i.e., toward the rear end).

As a result of this one cycle, the mover 1 has shifted toward the front end by the magnitude of expansion of the drive element 12. As the magnitude of expansion of the drive element 12 is very little, the magnitude of shift of the mover 1 per cycle is very little, too. However, by repeatedly carrying out this cycle a number of times, the mover 1 can be moved toward the front end to any arbitrary magnitude. For example, the magnitude of displacement of the drive element 12 may be about 1 nm and the drive frequency of the drive element 12 may be about 100 KHz.

To shift the mover 1 toward the rear end, the drive voltage applied to the drive element 12 may be increased steeply and then decreased gradually. Then, the drive body 17 will rapidly move toward the front end but the mover 1 will not move. Thereafter, as the drive body 17 moves gradually toward the rear end, the mover 1 also shifts toward the rear end. In this manner, the mover 1 can be shifted toward the rear end.

The holes 13b and 13d of the bearing portions 13a and 13c of the base member 13 support the drive body 17 so as to allow the drive body 17 to be displaced only in the longitudinal direction through those operations. The inner faces that define the holes 13b and 13d constrain the displacement of the drive body 17 perpendicular to the longitudinal direction thereof. However, there is a gap between the inner faces and the drive body 17. For that reason, no reactive force is applied to the holes 13b and 13d with respect to the force produced perpendicularly to the longitudinal direction of the drive body 17 as shown in FIG. 2. If the drive mechanism is described as a simple structural model, the drive body 17 may be regarded as a cantilever that uses the connection point P with the drive element 12 as a virtual fixed end. Nevertheless, the fixed end is movable according to the designed bonding strength or mechanical strength of the structure. For example, the connection point Q between the drive element 12 and a third bearing portion 13e may also be regarded as the fixed end.

That is why if the drive element 12 expands, the drive body 17 starts to be accelerated in the direction indicated by the arrow A. The mover 1 is also accelerated in the direction indicated by the arrow A under the friction Fs. However, this frictional force vector does not pass the center of mass G of the mover 1, and does not cancel the vector of the inertial force Fm, either, thus producing a moment M in the mover 1.

Since the mover 1 is constrained to the drive body 17, this moment M acts on the drive body 17. Supposing the drive body 17 is a cantilever that uses the connection point P with the drive element 12 as a fixed end as described above, the front end portion thereof, which is a free end, swings in the direction indicated by the arrow R. As a result, the mover 1 also swings in the direction indicated by the arrow V. This is an unnecessary vibration of the mover 1.

To damp this vibration, the drive mechanism of this preferred embodiment includes a viscoelastic body 5 between the drive body 17 and the inner faces of the bearing portions 13a and 13c of the base member 13 that define the holes 13b and 13d perpendicularly to the longitudinal direction of the drive body 17 as shown in FIG. 2. The gap between the inner faces that define the holes 13b and 13d and the drive body 17 is fully closed with the viscoelastic body 5.

The viscoelastic body 5 may be a gel substance, for example. Considering its temperature property, the viscoelastic body 5 is preferably a silicone-based substance. Also, to maintain a good packing state with the leakage through the gap minimized by keeping the flowability low after the packing work, which needs flowable viscoelastic body, has been done, a substance that cures and changes from sol into gel upon the exposure to an ultraviolet ray, for example, is preferably used. The loss factor tan δ of the vibrations is preferably about 1.4 to about 1.7.

Hereinafter, it will be described what effects will be achieved by interposing the viscoelastic body 5. As shown in FIG. 2, when the drive element 12 expands, the frictional force Fs and the inertial force Fm produce a moment M in the mover 1 as described above. Consequently, this moment M causes the drive body 17 to swing in the direction R. However, since the gap between the drive body 17 and the hole 13b at the front end of the base member 13 is filled with the viscoelastic body 5 in this case, the viscoelastic body 5 achieves the effects of suppressing the displacement of the drive body 17 perpendicular to its longitudinal direction and decreasing the magnitude and velocity of the vibrations.

These effects achieved by the viscoelastic body 5 may be broken down into a viscosity term, which ideally constitutes resistance against velocity, and a spring term with respect to the displacement. Specifically, the viscosity term is produced by the shearing deformation of the viscoelastic body 5 to dissipate the energy due to the viscosity. On the other hand, the spring term may be produced by tensile or compressive deformation but its energy is ideally conserved. However, a viscoelastic body rarely works in its ideal state. And the energy is never dissipated completely by the viscosity term or the energy produced by the spring term is never conserved completely.

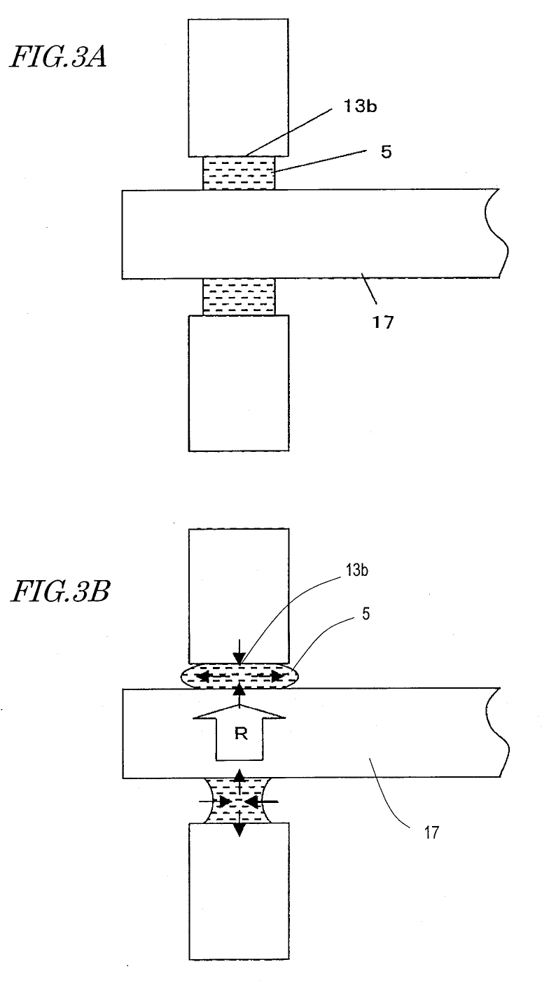

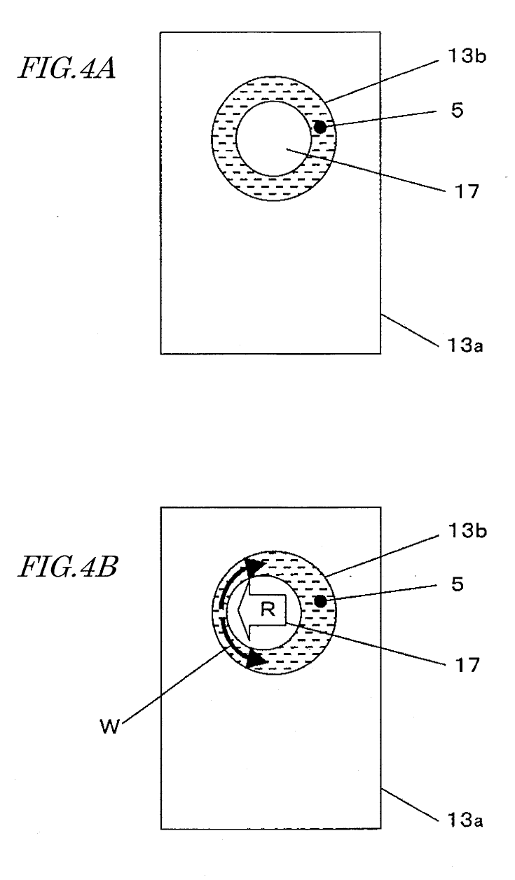

FIGS. 3A and 3B are enlarged cross-sectional views showing portions around the hole 13b at the front end. Specifically, FIG. 3A illustrates a situation where the drive body 17 has not been displaced perpendicularly yet, while FIG. 3B illustrates a situation where the drive body 17 has already been displaced perpendicularly. As indicated by the arrow R in FIG. 3B, it can be seen that when the drive body 17 is going to shift and be displaced perpendicularly to the longitudinal direction, the viscoelastic body 5 is subjected to deformations. As shown in this cross-sectional view, tensile and compressive deformations have been produced in the viscoelastic body 5. As a result, the displacement of the drive body 17 perpendicular to its longitudinal direction is suppressed.

FIGS. 4A and 4B illustrate the drive body 17, the hole 13b of the bearing portion 13a and surrounding portions as viewed from their front end. Specifically, FIG. 4A illustrates a situation where the drive body 17 has not been displaced perpendicularly yet, while FIG. 4B illustrates a situation where the drive body 17 has already been displaced perpendicularly. As indicated by the arrows W in FIG. 4B, as the drive body 17 is displaced in the direction R, the viscoelastic body 5 is going to flow in the directions W. The resultant shearing deformation of the viscoelastic body 5 dissipates the energy due to the viscosity and damps the vibrations.

Inside the hole 13d of the bearing portion 13c, the viscoelastic body 5 also works similarly and damps the vibrations, too. However, the drive body 17 is displaced in the direction R much less in the hole 13d than in the hole 13b. As a result, the velocity in the direction R decreases accordingly and the damping effect achieved is not so remarkable.

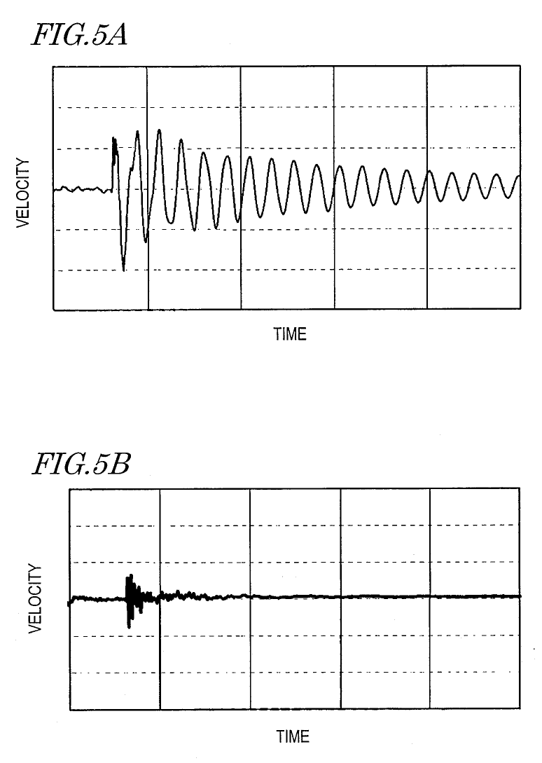

FIGS. 5A and 5B are graphs showing the velocity components of the mover 1 in the direction R in the vicinity of the hole 13b of the bearing portion 13a with and without the viscoelastic body 5, respectively. It can be seen that the shearing deformation of the viscoelastic body 5 dissipated the kinetic energy of the drive body 17 and the mover 1 due to the viscosity and reduced the amplitude significantly. It can also be seen that the vibrations attenuated steeply with time.

As described above, according to this preferred embodiment, by arranging the viscoelastic body between the drive body and the base member that limits the vibration direction of the drive body perpendicularly to the longitudinal direction of the drive body, the vibrations of the drive body perpendicular to the longitudinal direction thereof are damped by the shearing deformation of the viscoelastic body. Consequently, this drive mechanism can drive the mover with good stability with unnecessary vibrations damped. Also, an optical head including the drive mechanism of this preferred embodiment can perform a stabilized servo control.

In the preferred embodiment described above, the viscoelastic body 5 closes the gap between the inner face of the holes 13b and 13d and the drive body 17 entirely. Alternatively, the viscoelastic body 5 may be interposed only in the direction that is parallel to the plane on which the drive body 17 vibrates perpendicularly to the longitudinal direction under the moment received from the mover 1.

Also, in the preferred embodiment described above, the gap between the holes 13b, 13d and the drive body 17 is filled with the viscoelastic body 5. However, as long as the viscoelastic body 5 is subjected to shearing deformation while the drive body 17 is being displaced perpendicularly to the longitudinal direction, the viscoelastic body 5 may be arranged anywhere between the base member 13 and the drive body 17. Nevertheless, it is still effective to inject the viscoelastic body 5 into the holes 13b and 13d because the amount of the viscoelastic body 5 consumed is small in that case.

### Embodiment 2

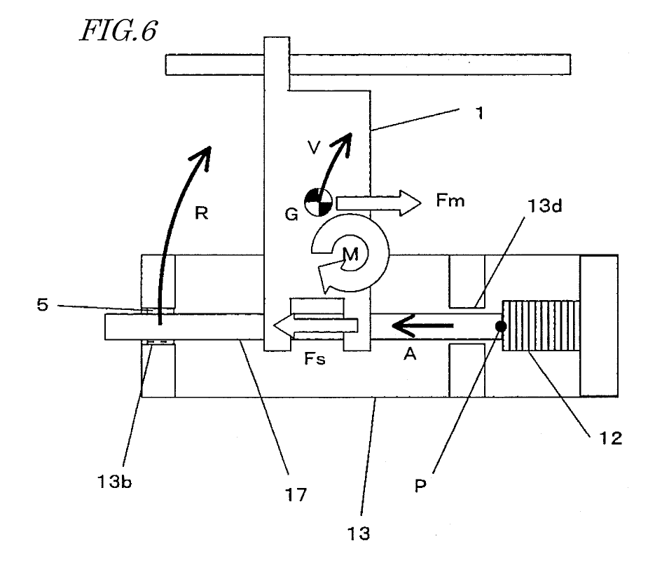

FIG. 6 illustrates a second preferred embodiment of the drive mechanism. This second preferred embodiment is different from the first preferred embodiment described above in that the hole 13d of the bearing portion closer to the drive element 12 is not filled with the viscoelastic body 5.

As already described for the first preferred embodiment, the drive body 17 is displaced more greatly, and the vibrations of the drive body 17 perpendicular to the longitudinal direction thereof can be damped more effectively, at the bearing portion 13b. That is why this second preferred embodiment is effectively applicable to a situation where the amount of the viscoelastic body 5 to be injected should be limited due to cost, assembling or any other consideration. This preferred embodiment would achieve the same effects as those of the first preferred embodiment described above.

Comparing the displacements inside the holes 13b and 13d of the bearing portions to each other, the displacement of the drive body 17 perpendicular to the longitudinal direction thereof is not so much in the hole 13d as in the hole 13b, and therefore, the vibrations can be damped less effectively in the hole 13d than in the hole 13b. Meanwhile, the viscoelastic body 5 would suppress the displacement of the drive body 17 in the longitudinal direction (i.e., in the direction A), which is an essential movement of the drive body 17, almost equally in these two holes 13b and 13d. For that reason, depending on the mode of use, it could be preferable to provide the viscoelastic body 5 only for the hole 13b. Optionally, as in the first preferred embodiment described above, it is also effective to provide the viscoelastic body 5 between a portion of the drive body 17 close to its free end and another portion of the base member 13.

### Embodiment 3

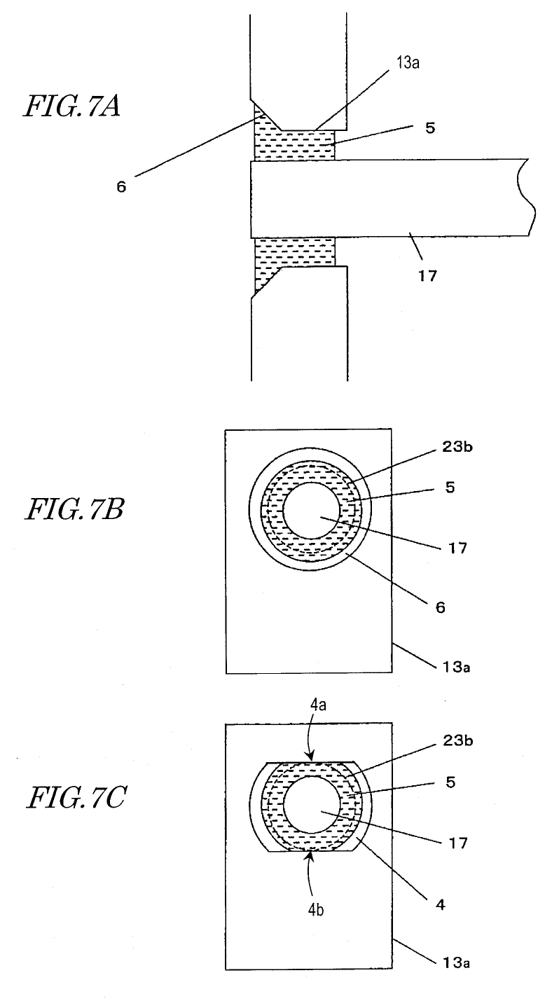

FIGS. 7A and 7B illustrate the principal portion of a third preferred embodiment of the drive mechanism.

This preferred embodiment is different from the first preferred embodiment in the structure of the bearing portion 13a of the base member 13. More specifically, the bearing portion 13a has a hole 23b, to which the drive body 17 is inserted, and a chamfered portion 6 at the opening of the hole 23b.

As in the first preferred embodiment described above, the hole 23b is defined by a cylindrical inner face (corresponding to the first surface). This inner face defines a circle, of which the diameter is slightly greater than that of the circular cross section of the drive body 17. The inner face is located with a predetermined very small gap left with respect to the side surface of the drive body 17. The chamfered portion 6 is defined by a tapered inner face (corresponding to the second surface) and the gap between the chamfered portion 6 and the side surface of the drive body 17 changes in the longitudinal direction. More specifically, the gap increases toward the front end of the drive body 17 to expand the opening area of the hole 23b. That is why the gap between the inner face of the chamfered portion 6 and the side surface of the drive body 17 is greater than the gap between the hole 23b and the side surface of the drive body 17. As shown in FIG. 7A, the inner face that defines the hole 23b and the inner face that defines the chamfered portion 6 are located adjacent to each other in the longitudinal direction of the drive body 17. As shown in FIG. 6B, the chamfered portion 6 surrounds the hole 23b entirely. The viscoelastic body 5 is arranged between the chamfered portion 6 or the hole 23b and the drive body 17.

In this preferred embodiment, the chamfered portion 6 is provided independently of the hole 23b that constrains the displacement of the drive body 17 perpendicular to the longitudinal direction thereof. Even so, the viscoelastic body 5 still achieves the same effects as those of the first preferred embodiment but the assembling process can get done much more perfectly when the viscoelastic body 5 is injected into the hole 23b. More specifically, first of all, as there is the chamfered portion 6, the viscoelastic body 5 can be injected easily. Furthermore, if the viscoelastic body 5 is a UV curable substance, the chamfered portion 6 would allow the incoming UV ray to reach deeper inside, make it easier to define the angle of incidence of the UV ray, and cut down the cost by shorting the irradiation process time.

FIG. 7C illustrates a modified example of this preferred embodiment. As shown in FIG. 7C, the chamfered portion 4 may be provided for only portions of the hole 23b. The gap between the inner face of the non-chamfered portions 4a, 4b and the side surface of the drive body 17 is equal to the gap between the hole 23b and the side surface of the drive body 17 as shown in FIG. 7C. That is why those non-chamfered portions 4a, 4b constrain the displacement of the drive body 17 perpendicular to the longitudinal direction thereof as well as the hole 23b. As a result, the area of the regulating faces increases and the drive body 17 can be constrained more perfectly. In terms of the simplicity of the assembling process, however, the structure shown in FIG. 7B is superior to that shown in FIG. 7C.

### Embodiment 4

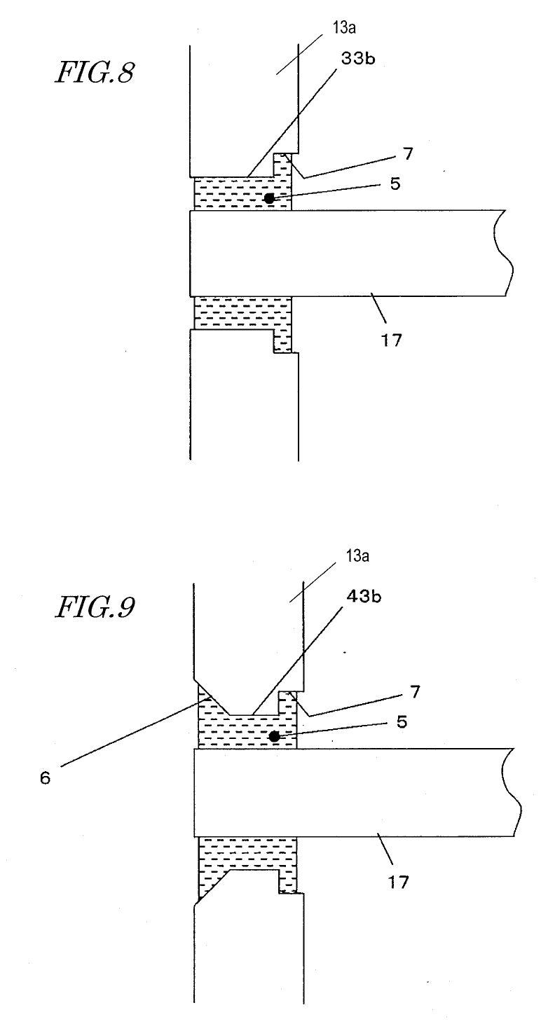

FIG. 8 illustrates the principal portion of a fourth preferred embodiment of the drive mechanism. This preferred embodiment is different from the first preferred embodiment in the structure of the bearing portion 13a of the base member 13. More specifically, the bearing portion 13a has a hole 33b, into which the drive body 17 is inserted, and another hole 7, which is located adjacent to one opening of the hole 33b and which has a greater inside diameter than the hole 33b. The hole 7 is preferably located closer to the mover 1 than the hole 33b is.

As in the first preferred embodiment described above, the hole 33b is defined by a cylindrical inner face (corresponding to the first surface). This inner face defines a circle, of which the diameter is slightly greater than that of the circular cross section of the drive body 17. The inner face is located with a predetermined very small gap left with respect to the side surface of the drive body 17.

The hole 7 is defined by another cylindrical side surface (corresponding to the second surface) and has a greater inside diameter than the hole 33b. That is why the gap between the inner face of the hole 7 and the side surface of the drive body 17 is greater than the gap between the hole 33b and the side surface of the drive body 17. As shown in FIG. 8, the inner face that defines the hole 33b and the inner face that defines the hole 7 are located adjacent to each other in the longitudinal direction of the drive body 17. A higher reliability would be achieved by cutting the hole 7 all around the drive body 17.

In this preferred embodiment, the hole 7 is provided independently of the hole 33b that constrains the displacement of the drive body 17 perpendicular to the longitudinal direction thereof. Even so, the viscoelastic body 5 still achieves the same effects as those of the first preferred embodiment and a higher degree of reliability would be achieved in terms of drivability. In addition, the assembling process can get done much more perfectly when the viscoelastic body 5 is injected into the hole 33b.

More specifically, without the hole 7, if the viscoelastic body 5 were injected from the left-hand side of FIG. 8, even a very small variation in the amount of the viscoelastic body 5 injected would make the density of the viscoelastic body 5 insufficient or excessive because the gap between the hole 33b and the drive body 17 is very narrow. That is to say, if the viscoelastic body were injected too much, the viscoelastic body 5 would overflow out of the hole 33b to change the degree of friction between the drive body 17 and the mover 1 or deposit the viscoelastic body 5 on an optical member for the mover 1. On the other hand, if the viscoelastic body 5 were injected too little, then the vibration damping effect would not be achieved consistently.

Meanwhile, with the hole 7, if the viscoelastic body 5 were injected from the left-hand side of FIG. 8, the penetration rate of the viscoelastic body 5 would drop steeply at the cylindrical hole 7 because the cross-sectional area of the hole 7 is much bigger than that of the hole 33b. That is why if the amount of the viscoelastic body injected needs to be monitored, the control can get done more easily. In addition, in a situation where the amount of discharge is supposed to be a predetermined volume, even a variation in the amount of discharge would not make the density too high or too low because the volume of the cylindrical hole 7 acts as a buffer.

### Embodiment 5

FIG. 9 illustrates the principal portion of a fifth preferred embodiment of the drive mechanism.

In the structure of this preferred embodiment, both the chamfered portion 6 of the third preferred embodiment and the hole of the fourth preferred embodiment are provided for the bearing portion 13a. Specifically, the bearing portion 13a has a hole 43b and a chamfered portion 6 and a hole 7 that are arranged so as to interpose the hole 43b between them in the longitudinal direction. As a result, the advantages of the third and fourth preferred embodiments are obtained at the same time.

As already described for the third preferred embodiment, the chamfered portion 6 may be provided for only portions of the hole 43. On the other hand, in view of the reliability to achieve, the hole 7 preferably surrounds the drive body 17 entirely.

In the third through fifth preferred embodiments, the shapes of the chamfered portion 6 and the hole 7 may be different from the exemplary ones described above. For example, the chamfered portion 6 and the hole 7 may have asymmetrical shapes with respect to the longitudinal axis of the drive body 17. Optionally, the chamfered portion 6 and the hole 7 may be provided for the bearing portion closer to the drive element 12.

### Embodiment 6

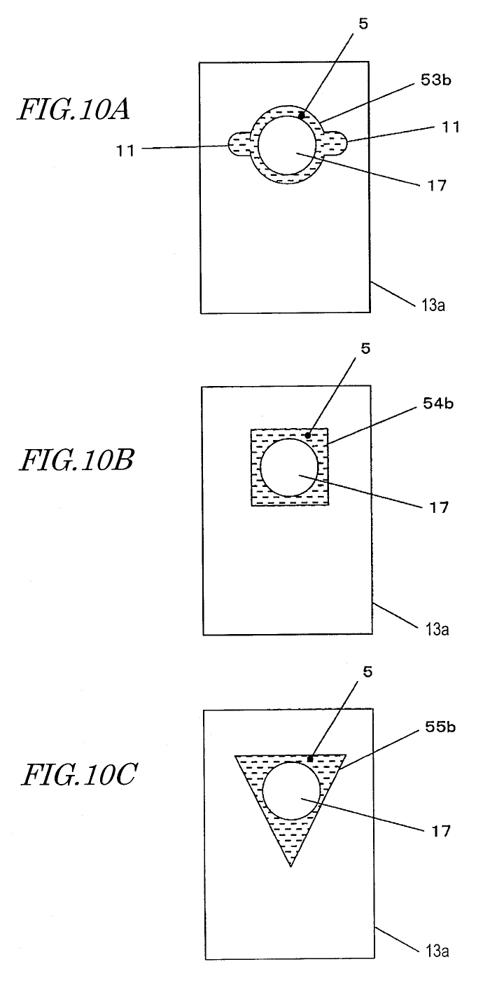

FIG. 10A illustrates the principal portion of a sixth preferred embodiment of the drive mechanism. This preferred embodiment is different from the first preferred embodiment described above in the structure of the bearing portion 13a of the base member 13. Specifically, the bearing portion 13a has a hole 53b, to which the drive body 17 is inserted, and auxiliary holes 11. As shown in FIG. 10A, on a cross section perpendicular to the longitudinal direction of the drive body 17, portions of the arc that defines the hole 53b are expanded into the auxiliary holes 11 having a greater inside diameter than that of the hole 53b. Since the inside diameter of the auxiliary holes 11 is greater than that of the hole 53b, the gap between the inner faces defining the auxiliary holes 11 and the side surface of the drive body 17 is greater than the gap between the hole 53b and the side surface of the drive body 17. The viscoelastic body 5 has been injected into the gaps between the inner faces defining these holes and the drive body 17.

This preferred embodiment would achieve the same effects as those produced by the second preferred embodiment described above. Among other things, in the assembling process, the viscoelastic body 5 can be injected very easily due to the presence of the auxiliary holes 11.

In this preferred embodiment, there are two auxiliary holes 11. However, the number and shape of the auxiliary holes 11 are not limited to those shown in FIG. 10A. Instead, any other number of auxiliary holes in any other shape may be provided as long as those holes do not interfere with the function of the hole 53b as a regulating face and make it easier to inject the viscoelastic body 5. For example, the number of auxiliary holes 11 of this preferred embodiment may be just increased.

Optionally, an auxiliary hole in any other shape may be provided as shown in FIGS. 10B and 10C. In the examples shown in FIGS. 10B and 10C, a hole functioning as a regulating face that constrains the displacement of the drive body 17 perpendicular to the longitudinal direction thereof and an auxiliary hole are combined into an integrated shape. Specifically, holes 54b and 55b that respectively have a square cross section and a triangular cross section perpendicularly to the longitudinal direction have been cut through the bearing portion 13a.

This preferred embodiment may be appropriately combined with the third through fifth preferred embodiments described above. Optionally, the auxiliary hole of this preferred embodiment may also be provided for the bearing portion 13c closer to the drive element 12.

### Embodiment 7

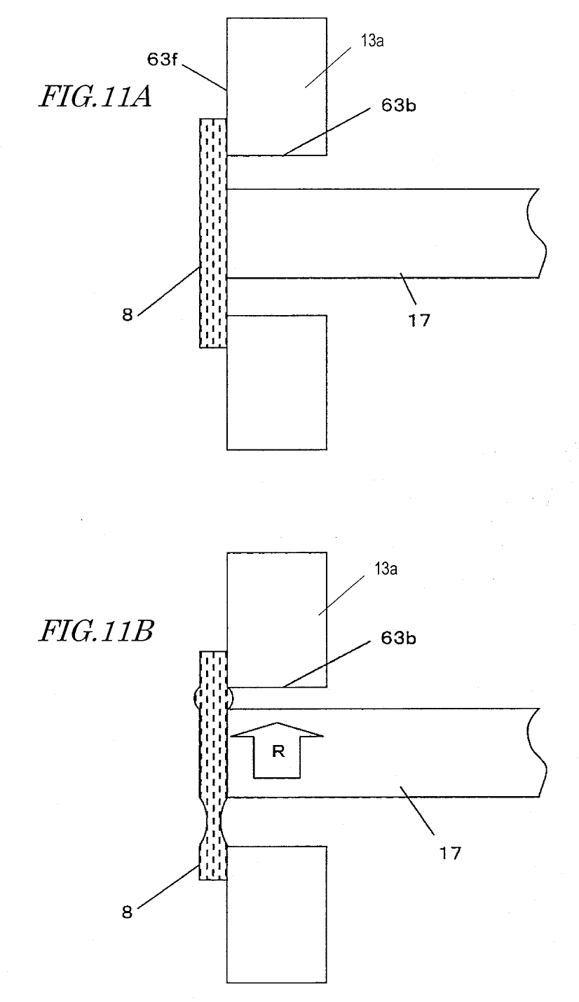

FIGS. 11A and 11B illustrate the principal portion of a seventh preferred embodiment of the drive mechanism. Specifically, FIG. 11A illustrates how the drive mechanism looks before the drive body 17 is displaced, while FIG. 11B illustrates how the drive mechanism looks after the drive body 17 has been displaced.

This preferred embodiment is different from the second preferred embodiment described above in the structure of the bearing portion 13a of the base member 13 that is located away from the drive element 12.

As shown in FIG. 11A, a viscoelastic body 8 is arranged so as to connect the other end face of the drive body 17, which is opposite to the end face secured to the drive element 12, and the bearing portion 13a of the base member 13 together. The viscoelastic body 8 has a plate or tape shape and is bonded to the end face 63f of the bearing portion 13a and to the end face of the drive body 17.

When the drive body 17 is displaced in the direction R, the viscoelastic body 8 is deformed as shown in FIG. 11B. In this case, the viscoelastic body 8 is subjected to not only elastic deformation but also shearing deformation as well. As a result, the vibrations of the drive body 17 can be damped as already described for the second preferred embodiment.

According to this preferred embodiment, the viscoelastic body 8 has lower resistance to the displacement of the drive body 17 in the longitudinal direction than in the first through sixth preferred embodiments, thus achieving the advantage of causing smaller loss for the driving force applied to the mover 1. In addition, according to this preferred embodiment, there is no need to fill the gap with the viscoelastic body but a member like a tape with double adhesive layers may be used as the viscoelastic body 8. As a result, the assembling process can get done more easily.

### Embodiment 8

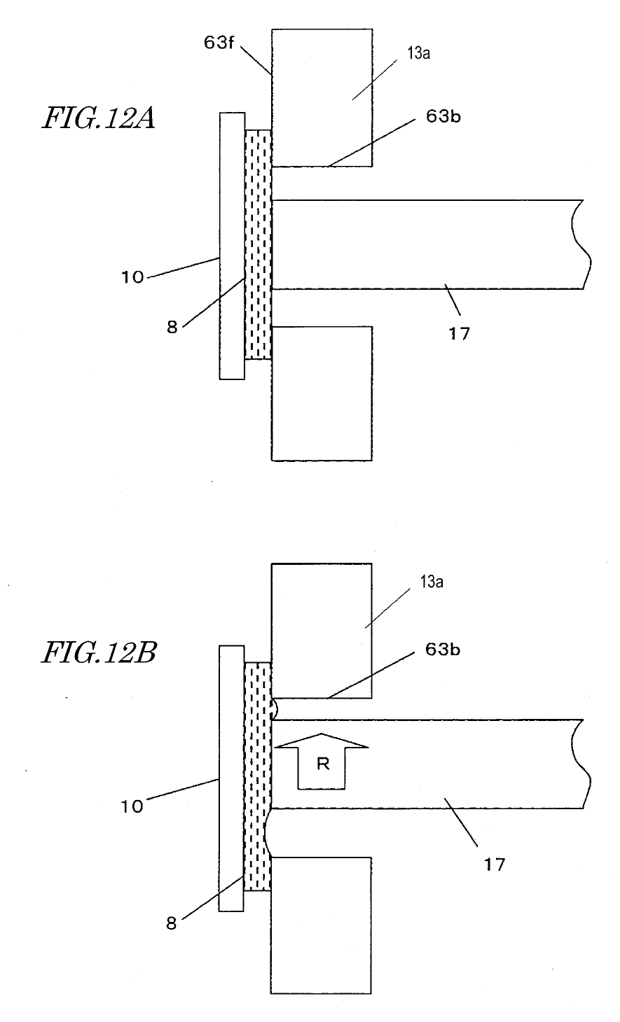

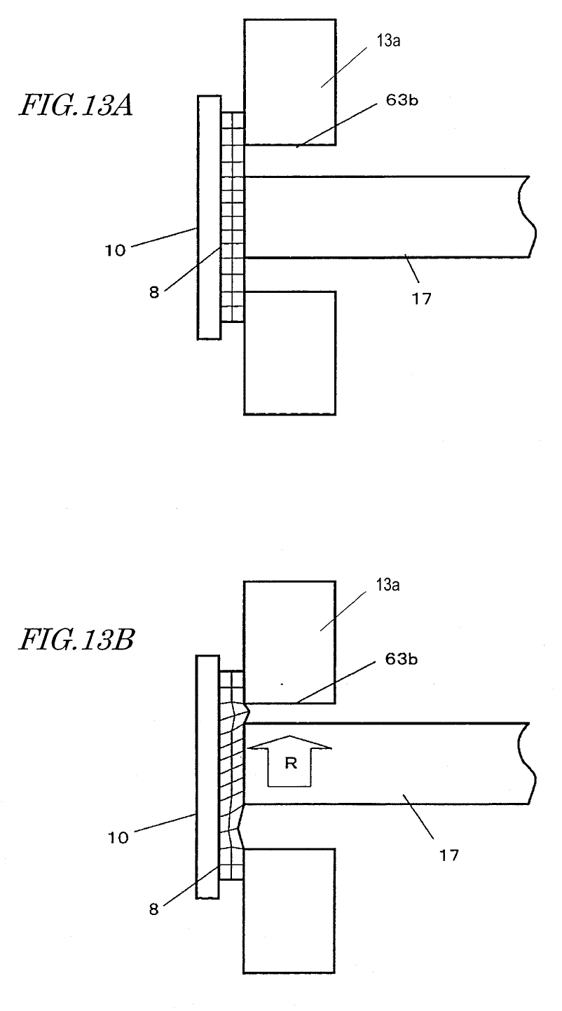

FIGS. 12A and 12B illustrate the principal portion of an eighth preferred embodiment of the drive mechanism. Specifically, FIG. 12A illustrates how the drive mechanism looks before the drive body 17 is displaced, while FIG. 12B illustrates how the drive mechanism looks after the drive body 17 has been displaced.

This preferred embodiment is different from the seventh preferred embodiment described above in that a support plate 10 is provided for the viscoelastic body 8.

The support plate 10 is arranged in contact with the other side of the plate viscoelastic body 8 that is not in contact with the end face of the drive body 17. The support plate 10 may be made of a material with relatively high rigidity (e.g., a material that at least has a greater modulus of shear elasticity than the viscoelastic body 8).

The support plate 10 has a greater modulus of shear elasticity than the viscoelastic body 8. For that reason, even if shearing deformation has been produced on one side of the viscoelastic body 8 that is in contact with the end face of the drive body 17 and the surface 63f of the bearing portion 13a, substantially no shearing deformation will be produced on the other side of the viscoelastic body 8 that is provided with the support plate 10.

Therefore, even if the drive body 17 has been displaced in the direction R, the other side of the viscoelastic body 8 with the support plate 10 will be hardly deformed but the one side in contact with the end face of the drive body 17 will be deformed greatly as shown in FIG. 12B. As a result, significant shearing deformation will be produced due to the difference between these two sides.

FIGS. 13A and 13B illustrate, using a mesh model, how the viscoelastic body 8 changes its shapes before and after the drive body 17 is displaced. It can be seen that the small elements of the viscoelastic body 8 that are shown as square ones in FIG. 13A have been deformed significantly in FIG. 13B due to shearing strain. Thus, this preferred embodiment would achieve greater vibration damping effects than those produced by the seventh preferred embodiment described above. The support plate 10 does not have to be made of a special material but may be made of a normal cheap plate metal, for example.

### Embodiment 9

Hereinafter, a preferred embodiment of an optical head according to the present invention will be described.

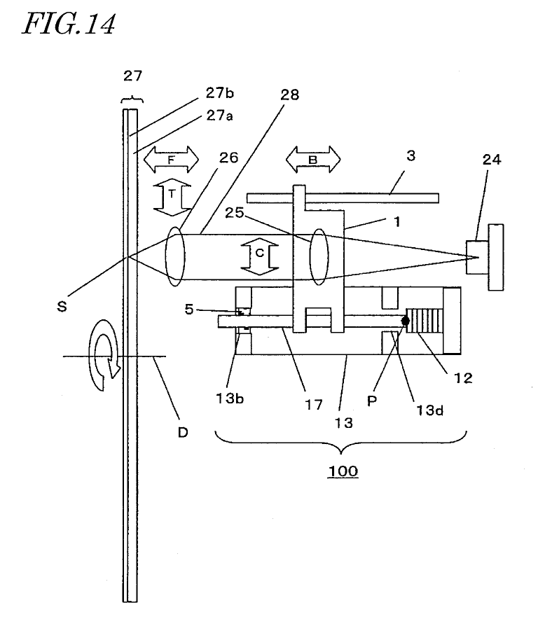

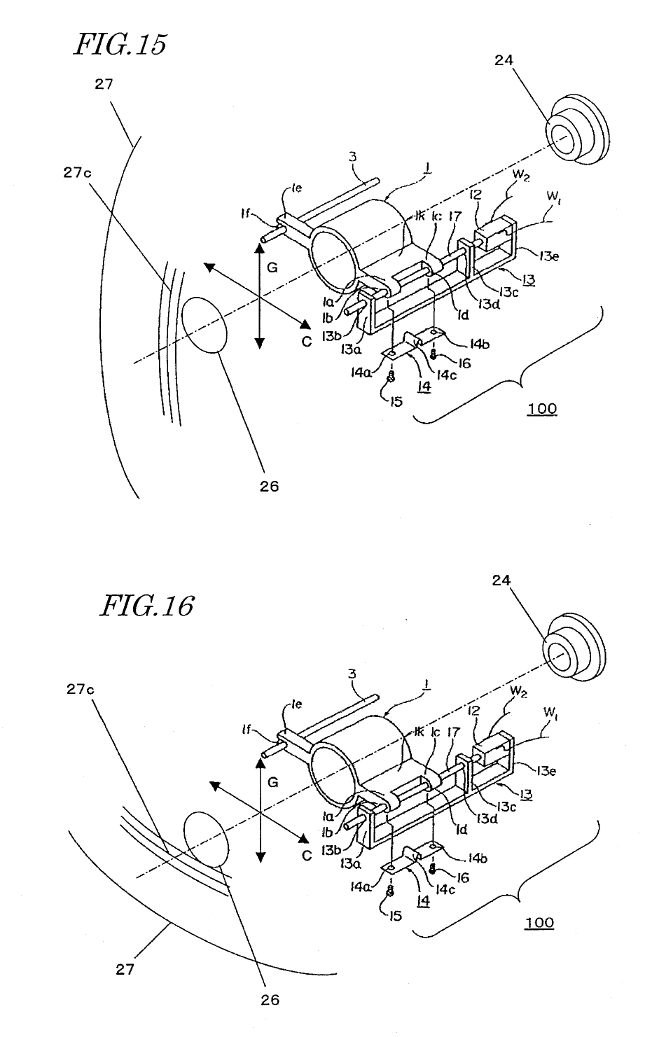

FIGS. 14 and 15 schematically illustrate the principal portion of an optical head as a ninth preferred embodiment of the present invention. As shown in FIG. 14, the optical head includes the drive mechanism 100 that has already been described as the second preferred embodiment. The mover 1 of the drive mechanism includes an aberration correction lens 25. The optical head further includes a semiconductor laser 24 as a light source and an objective lens 26.

The storage medium 27 includes a transparent coating layer 27a, which is arranged so as to face the objective lens 26, and a storage layer 27b under the coating layer 27a. The storage medium 27 is arranged so as to be turned around an axis D by a motor (not shown). On the storage layer 27b, formed is a spiral recording track 27c, which is wound substantially around the same axis D.

As already described for the second preferred embodiment, the aberration correction lens 25 is built in the mover 1 of the drive mechanism 100, of which the bearing portion 13a is filled with the viscoelastic body 5. The aberration correction lens 25 and the drive mechanism 100 together form a spherical aberration correction mechanism.

FIG. 15 is a perspective view of the principal portion shown in FIG. 14. A tangential line for the recording track 27c intersects with the direction C at right angles. It is in the direction C that vibrations are produced in the drive mechanism 100. The objective lens 26 is freely driven in the directions indicated by the arrows F and T by a holding system and a driving system (neither of which is shown), and converges incoming laser beam 28 and forms a light beam spot S according to the degrees of flutter of the recording track and eccentricity of the storage medium 27. The drive mechanism 100 moves the aberration correction lens 25 in the directions indicated by the arrow B and can correct a spherical aberration to be produced by a variation in the thickness of the protective coating 27a.

Hereinafter, it will be described how the optical head with such a configuration operates. The laser beam 28 that has been emitted from the semiconductor laser 24 is transmitted through the aberration correction lens 25 and then converged by the objective lens 26 as a light beam spot S on the storage layer 27b. The objective lens 26 is driven in the directions indicated by the arrows F and T according to the degrees of flutter and eccentricity of the recording track to correct defocusing and off-track and scan the target recording tracks 27c with the laser beam 28 that has been converged into the light beam spot S. The drive mechanism 100 shifts the aberration correction lens 25 in the directions indicated by the arrow B according to the magnitude of variation in the thickness of the protective coating 27a, thereby correcting the spherical aberration.

As the aberration correction lens 25 vibrates in the directions indicated by the arrow C due to the acceleration produced while the lens 25 is being accelerated or decelerated, the light beam spot S also shifts from the recording track 27c in the direction T, which is the off-track direction. Were it not for the viscoelastic body 5, the aberration correction lens 25 could vibrate too much to get the read/write operations done with stability. With the viscoelastic body 5, however, not only the amplitude but also the duration of the vibrations will decrease due to the viscosity dissipating effect as already described with reference to FIGS. 5A and 5B. As a result, the vibrations of the aberration correction lens 25 can be reduced to such a level as to be corrected easily with the objective lens. Consequently, the optical head can perform a read/write operation with good stability.

### Embodiment 10

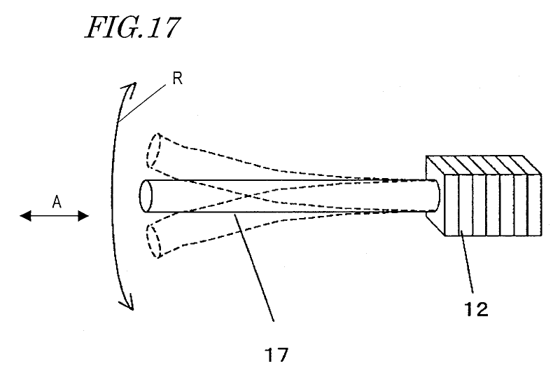

FIG. 16 schematically illustrates the principal portion of another preferred embodiment of an optical head according to the present invention. The Components of the optical head of this preferred embodiment are the same as the counterparts of the ninth preferred embodiment just described. Although not shown, the bearing portion 13a is filled with the viscoelastic body 5. The optical head of this preferred embodiment is different from the ninth preferred embodiment in that the tangential line for the recording tracks 27c is parallel to the direction C. It is in the direction C that vibrations are produced in the drive mechanism 100.

With such an arrangement, when the mover 1 is displaced in one of the directions indicated by the arrow C, the light beam spot shifts in the tangential direction with respect to the recording tracks 27c. That is why jitter components will be produced in the information that has been read. However, the influence of the jitter can be minimized thanks to the effect caused by the viscoelastic body 5. Also, such jitter components of the read information could be corrected through signal processing.

In the ninth and tenth preferred embodiments described above, the optical head includes the drive mechanism of the second preferred embodiment. Alternatively, the drive mechanism of one of the first and third through eighth preferred embodiments described above could also be used.

Also, in all of the preferred embodiments described above, the drive body 17 is supposed to be a shaft with a circular cross section. Optionally, the drive body 17 may have a rectangular cross section. In that case, the mover 1 could rotate only around the drive body 17 and the auxiliary guide shaft 3 would be no longer necessary.

Furthermore, in the preferred embodiments described above, a piezoelectric element is used as the drive element 12. Alternatively, an element such as an electromagnetic plunger may also be used.

Furthermore, in the preferred embodiments described above, the present invention has been described as a drive mechanism for driving the aberration correction lens of an optical head. However, the drive mechanism of the present invention can also be used in various other optical devices with a micro drive mechanism. For example, the drive mechanism of the present invention could also be used as a zooming mechanism to change the zoom power of an optical system for a digital still camera or a cellphone with a camera. Alternatively, the drive mechanism of the present invention could also be used as a drive mechanism to realize an autofocusing function.

Still alternatively, the drive mechanism of the present invention could also be applied to a fine and precise reciprocating mechanism that should be free of unnecessary vibrations for the purpose of micromanipulations, for example.

Also, according to the intended application, it is sometimes necessary to detect the position of the mover directly and accurately. In that case, a sensor for detecting the position of the mover may be provided for the drive mechanism.

### INDUSTRIAL APPLICABILITY

The present invention can be used effectively in a small drive mechanism, of which the mover should be shifted precisely. Among other things, the present invention is particularly effectively applicable for use in optical heads, digital still cameras, and various other optical devices in which the position of an optical element needs to be adjusted in order to correct the aberration of an optical system or to change the condensing states of the light or the zoom power of an optical system. The present invention can be used effectively in micromanipulations, too.

1. A drive mechanism comprising:
a drive body that defines a longitudinal direction;
a mover that makes a friction fit with the drive body so as to slide in the longitudinal direction and that is arranged such that its center of mass is not located on the drive body;
a base member that supports the drive body so as to allow the drive body to move in the longitudinal direction;
a drive element, which is secured to one end of the drive body to vibrate the drive body in the longitudinal direction; and
a viscoelastic body, which is arranged between the drive body and the base member in a direction perpendicular to the longitudinal direction and which produces shearing deformation when the drive body is displaced in the perpendicular direction.

2. The drive mechanism of claim 1, wherein the viscoelastic body is arranged at least in the vicinity of the other end of the drive body that is opposite to the end to which the drive element is secured.

3. The drive mechanism of claim 2, wherein the base member includes a bearing portion that has a first surface, which is arranged with a predetermined gap left in the perpendicular direction with respect to the drive body and which limits the movable range of the drive body in the perpendicular direction.

4. The drive mechanism of claim 2, wherein the base member includes at least two bearing portions, each of which has a first surface that is arranged with a predetermined gap left in the perpendicular direction with respect to the drive body, and
wherein the viscoelastic body is arranged in one of the bearing portions that is most distant from the drive element.

5. The drive mechanism of claim 3, wherein the viscoelastic body is arranged between the first surface and the drive body.

6. The drive mechanism of claim 3, wherein the bearing portion has a second surface that is arranged with another predetermined gap left in the perpendicular direction with respect to the drive body, the gap between the second surface and the drive body being greater than the gap between the first surface and the drive body.

7. The drive mechanism of claim 6, wherein the gap to the second surface changes in the longitudinal direction.

8. The drive mechanism of claim 6, wherein the bearing portion has two surfaces as the second surface, those two surfaces being arranged so as to interpose the first surface in the longitudinal direction.

9. The drive mechanism of claim 3, wherein the first and second surfaces of the bearing portion are adjacent to each other as viewed on a plane that is parallel to the perpendicular direction.

10. The drive mechanism of claim 1, wherein the viscoelastic body is arranged so as to connect the other end of the drive body that is opposite to the end to which the drive element is secured and the base member together.

11. The drive mechanism of claim 10, wherein the viscoelastic body is sheet.

12. The drive mechanism of claim 11, wherein the sheet viscoelastic body has first and second principal surfaces, the first principal surface being in close contact with the end face of the drive body and with the base member, the second principal surface being provided with a substance that has a greater modulus of shear elasticity than the viscoelastic body.

13. The drive mechanism of claim 1, wherein the viscoelastic body is made of a gel substance.

14. The drive mechanism of claim 1, wherein the viscoelastic body is made of a silicone substance.

15. The drive mechanism of claim 1, wherein the viscoelastic body is made of a UV curable resin.

16. The drive mechanism of claim 1, wherein the viscoelastic body has a vibration loss factor of 1.4 to 1.7.

17. The drive mechanism of claim 1, wherein the drive element is a piezoelectric element.

18. The drive mechanism of claim 1, wherein the drive element is secured to one end of the drive body and vibrates the drive body in the longitudinal direction at varying velocities or accelerations that change according to the direction of movement, thereby shifting the mover.

19. An optical head comprising:
a light source;
an optical element, which is arranged on the optical path of light emitted from the light source; and
the drive mechanism of claim 1 for moving the optical element,
wherein the optical head performs read and/or write operation(s) on a storage medium by converging the light emitted from the light source on the storage medium.

20. The optical head of claim 19, wherein as viewed on a plane that passes the center of mass of the mover and that intersects with a drive shaft at right angles, a line segment that connects the center axis of the drive shaft and the center of mass of the mover together is parallel to a recording track in the vicinity of a light beam spot on the storage medium.
